(19) United States
(12) Patent Application Publication
(10) Pub. No.: US 2025/0305156 A1
(43) Pub. Date: Oct. 2, 2025

(54) Microwave-assisted Solid Oxide Electrolysis Cell (SOEC), Proton Conducting Solid Oxide Electrolysis Cell (H-SOEC), Reversible Proton Conducting Solid Oxide Electrolysis Cell (rH-SOEC) or Reversible Solid Oxide Electrolysis Cell (rSOEC) for Hydrogen Production

(71) Applicant: United States Department of Energy, Washington, DC (US)

(72) Inventors: Randall S. Gemmen, Morgantown, WV (US); Dushyant Shekhawat, Morgantown, WV (US); Alfred Unione, Pittsburgh, PA (US); Mark C. Williams, Morgantown, WV (US)

(21) Appl. No.: 18/617,295

(22) Filed: Mar. 26, 2024

(51) Int. Cl. C25B 1/50; C25B 1/042; C25B 9/19

(52) U.S. Cl. CPC C25B 1/50; C25B 1/042; C25B 9/19

(57) ABSTRACT

A method of enhancing an electrolysis reaction in a solid oxide electrolysis cell (SOEC) for hydrogen production featuring: providing a water vapor stream to a cathode chamber of a SOEC; wherein the SOEC has an cathode chamber and an anode chamber, wherein the cathode chamber contains a catalyst; and wherein the catalyst has one or more conducting oxides and one or more catalytically active materials dispersed within the conducting oxides; and applying an electromagnetic field to the SOEC with a prescribed frequency and pulse mode specific to interactions of the catalyst and the electromagnetic field with the SOEC; and applying a DC bias to the SOEC, resulting in production of some amount of hydrogen from the water vapor stream in the cathode chamber of the SOEC.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

Embodiments relate to methods for enhancing an electrolysis reaction in a solid oxide electrolysis cell (SOEC) for hydrogen production. More specifically, embodiments relate to methods of enhancing electrolysis reactions featuring the application of microwaves to the SOEC, with said microwaves providing targeted heating of the SOEC to improve the efficiency of the SOEC, providing energy to lower the activation energy for the electrolysis reaction, and enabling lower SOEC area specific resistance (ASR) and hence increased hydrogen production rates compared to conventional methods of hydrogen production using SOECs disclosed in the prior art.

### BACKGROUND

Hydrogen production using electrolysis is a topic of significant interest, especially for use as a clean energy source in industry and transportation. Electrolysis is an endothermic reaction wherein electricity is used to split water into hydrogen and oxygen. Electrolysis is a promising option for producing high-purity hydrogen from renewable resources. Electrolysis takes place in a cell called an electrolyzer which generally comprises an anode chamber and a cathode chamber separated by an electrolyte. Electrolyzers can be categorized according to the type of electrolyte material utilized and are typically one of three kinds: polymer electrolyte membrane electrolyzers (PEM) or proton exchange membrane electrolyzers, alkaline electrolyzers, and solid oxide electrolysis cells (SOEC). Each of these types of electrolyzers can produce hydrogen gas in the cathode chamber of the electrolyzer cell.

In particular, SOECs hold potential for sustainable hydrogen production using electrolysis. SOECs use a solid ceramic membrane as the electrolyte that selectively conducts negatively charged oxygen ions. In an SOEC, water vapor in the form of steam combines with electrons from an external circuit at the cathode to form hydrogen gas and negatively charged oxygen ions. The oxygen ions pass through the solid ceramic membrane and react at the anode to form oxygen gas and generate electrons for the external circuit.

Thermodynamically, electrolysis of water becomes increasingly endothermic as temperature increases, and thus it is more energy efficient to electrolyze water at high temperatures. Notably, SOECs must operate at temperatures high enough for the solid oxide membranes to function properly, with said temperatures generally greater than about 773 K. Therefore, SOECs are thermodynamically more favorable for electrolysis compared to other kinds of electrolyzers, which must operate at lower temperatures.

Generally, SOECs require the addition of heat into the system to support the endothermic electrolysis reaction below the thermal neutral point of the reaction. Traditionally, this additional heat is provided by using electricity from a power grid to resistively heat the SOEC cell, and said heat subsequently transferred to the reaction medium by convection. In many regions of the country, conventional power grids are not ideal for providing the electricity required for electrolysis, as non-renewable sources of energy release greenhouse gases and consume large amounts of fuel due to the low efficiency of the electricity generation process. Further, resistive heating of the SOEC shortens its lifetime dramatically. At bottom, conventional SOEC heating methods found in the prior art are inherently accompanied by large capital and operating costs, increased greenhouse gas emissions, and high hydrogen production costs.

Embodiments of the invention described herein improve the efficiency of the SOEC by using microwave energy as an alternative method to resistive heating. Traditionally, the cost to produce resistive heat using the SOEC itself is orders of magnitude higher than the cost of using microwave heating and also shortens the SOEC's lifetime. In an embodiment, microwave energy provides targeted heating of the SOEC, more specifically, targeted heating of the triple phase boundary formed at catalyst-cathode interface in the cathode chamber of the SOEC, where the electrolysis reaction occurs. Further, in an embodiment, a focused energy band of microwave energy is directed and contained at the SOEC's cathode chamber without expending additional energy outside of it. Additionally, in an embodiment, microwave heating is much faster than conventional SOEC heating, and in an embodiment, microwave heating is used to lower the activation energy of the electrolysis reaction, further promoting SOEC energy efficiency. Finally, at higher temperatures, SOECs demonstrate lower passivation and degradation in performance, and in an embodiment, microwave heating is utilized to decrease said passivation and degradation of the SOEC.

Additionally, embodiments of the invention described herein improve the efficiency of the SOEC using microwave energy to lower the SOEC's area specific resistance (ASR), resulting in increased current densities anywhere in the electrolyzer cell where the microwave energy reduces ASR, and increased hydrogen production rates. The SOEC's internal polarization resistance, of which ASR is a component, follows an Arrhenius expression, and thus an SOEC's measured ASR greatly decreases at increased temperatures. In an embodiment, this increased temperature is facilitated using microwave heating. Consequently, for any applied DC bias and water vapor partial pressure, an increase in temperature will increase the current density and thus the hydrogen production rate. Further, with a lower ASR, more externally supplied heat is supplied using microwaves, increasing SOEC efficiency. Between approximately a 4% to approximately 25% improvement in SOEC efficiency, depending on the ASR, has been reportedly achieved by lowering SOECs' ASRs.

Embodiments of the invention described herein are suitable to be combined with waste heat streams to decrease the amount of external electrical energy needed to heat and power the SOEC to produce hydrogen. Coupled to waste heat streams, SOECs have reportedly achieved an electrical efficiency of up to about 90%, whereas other types of electrolyzers that must operate at lower temperatures, including PEMs and alkaline electrolyzers, achieved electrical efficiencies of up to about 60% to 75%. Consequently, in some embodiments of the invention described herein, microwave heating combined with waste heat streams, result in higher SOEC performance, greater SOEC electrical efficiency and lower electricity use, lower SOEC ASR, higher current density utilized in the SOEC, increased SOEC lifetime, increased hydrogen production rate, and overall decreased hydrogen production costs.

A need exists in the art for a more energy efficient and cost-effective method of heating and powering SOECs for hydrogen production that overcomes the disadvantages of the prior art. The novel method and principles of operation are further discussed in the following description.

### SUMMARY

Embodiments of the invention provide methods for enhancing an electrolysis reaction in a solid oxide electrolysis cell (SOEC) for hydrogen production. Traditional hydrogen production in SOECs using conventional resistive heating is inefficient, costly, and potentially damaging to the environment, as said heat is provided by using electricity from the power grid, including from non-renewable sources. Further, resistively heating an SOEC shortens its lifetime. One object of the invention is to enhance the efficiency of SOECs by using a targeted means of providing the required thermal energy for the electrolysis reaction in the SOEC using microwaves. An embodiment of the invention described herein applies microwave frequencies specific to the electrolysis reaction to the SOEC, particularly at the electrolysis reaction site itself. An embodiment of the invention described herein utilizes microwave heating to lower SOEC area specific resistance (ASR), enabling an increased hydrogen production rate and increased SOEC DC efficiency. In some embodiments of the invention described herein, coupling the use of microwave heating and thermal waste streams result in increased SOEC lifespan, increased SOEC energy efficiency, and lower overall hydrogen production costs.

The invention provides a method of enhancing an electrolysis reaction in a solid oxide electrolysis cell (SOEC) for hydrogen production applications comprising the steps of: providing a water vapor stream to a cathode chamber of a SOEC; wherein the SOEC comprises the cathode chamber and an anode chamber, wherein the cathode chamber contains a catalyst; and wherein the catalyst comprises one or more conducting oxides and one or more catalytically active materials dispersed within said conducting oxides; and applying an electromagnetic field to the SOEC with a prescribed frequency and pulse mode specific to interactions of the catalyst and the electromagnetic field with the SOEC; and applying a DC bias to the SOEC, resulting in production of some amount of hydrogen from the water vapor stream in the cathode chamber of the SOEC.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 is a flowchart for a method of enhancing an electrolysis reaction in a solid oxide electrolysis cell (SOEC) for hydrogen production, in accordance with the features of the present invention;

FIG. 2 is a simplified schematic of a conventional SOEC, in accordance with the features of the present invention;

FIG. 3 is a graph showing the relationship between required heat addition and ASR for any given current in a SOEC, in accordance with the features of the present invention;

FIG. 4 is a graph showing the fraction of total external energy that must be supplied as external heat for the SOEC electrolysis reaction for any given current, where the Y-axis is the power of heat, JQ/nF, divided by the total power, JQ/nF+P (heat power and electrical power), in accordance with the features of the present invention;

FIG. 5 is a graph showing the relationship between SOEC DC efficiency and hydrogen production rate, in accordance with the features of the present invention

FIG. 6 is an exemplary embodiment of a button cell, in accordance with the features of the present invention;

FIG. 7 is an exemplary embodiment of a model button cell and waveguide configuration for COMSOL modeling of microwave heating, in accordance with the features of the present invention;

FIG. 8 is a COMSOL model output of electric field ranges for a button cell, in accordance with the features of the present invention;

FIG. 9 is a COMSOL model output of electromagnetic power loss density ranges for a button cell, in accordance with the features of the present invention;

FIG. 10 is a COMSOL model output of temperature ranges for a stacked button cell, in accordance with the features of the present invention.

### DETAILED DESCRIPTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

In an embodiment, microwaves enhance the efficiency of SOECs through a targeted means of providing the required thermal energy for the electrolysis reaction and also energy to lower the activation energy of the electrolysis reaction. In an embodiment, these objectives are achieved by applying specific microwave frequencies to the SOEC for the electrolysis reaction, particularly at the electrolysis reaction site which is at the triple phase boundary of the catalyst-cathode interface within the cathode chamber of the SOEC. Also, microwave heating enables lower SOEC area specific resistance (ASR), enabling an increased hydrogen production rate and increased SOEC DC efficiency. In an embodiment, using targeted microwave frequencies induces faster electrolysis reaction kinetics resulting in lower SOEC ASR. Ultimately, lower SOEC ASR results in lower overall hydrogen production costs.

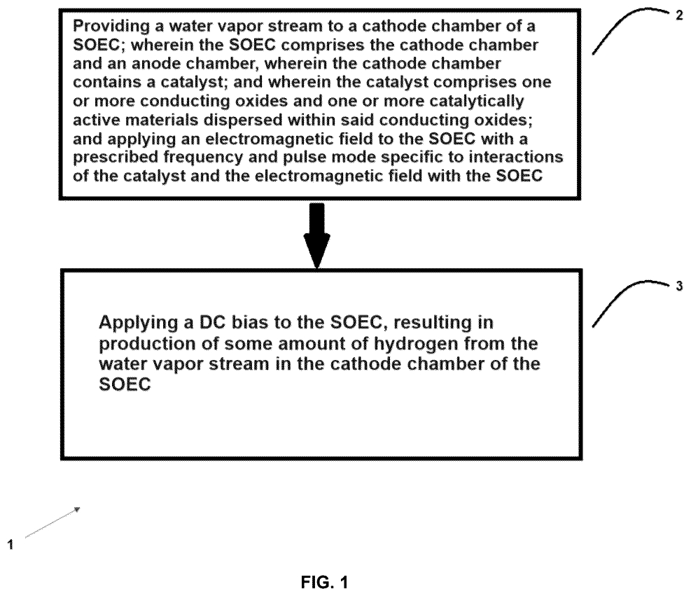

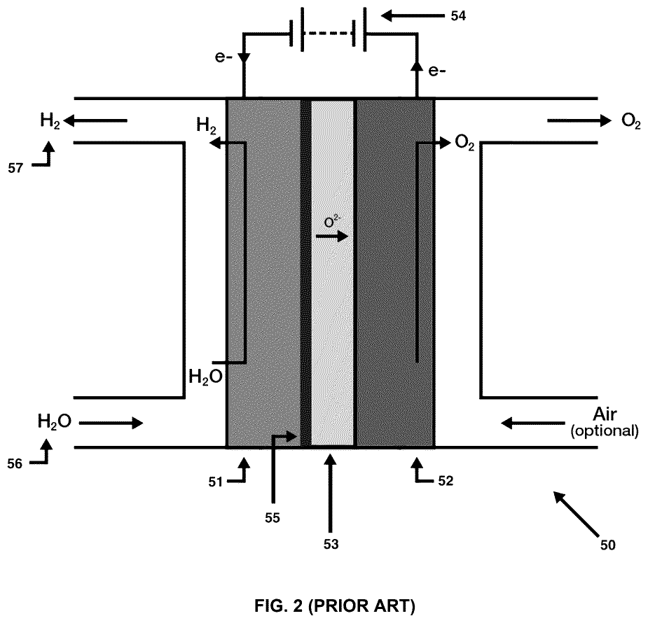

FIG. 1 depicts a flowchart for a method 1 of enhancing an electrolysis reaction in a solid oxide electrolysis cell (SOEC) for hydrogen production. An exemplary simplified configuration of an SOEC 50 is shown in FIG. 2 comprising a cathode chamber 51 in fluid communication with an electrolyte 52 in fluid communication with an anode chamber 52, wherein a voltage source 54 is in electric communication with the cathode chamber 51 and the anode chamber 52. As shown in FIG. 2, a triple phase boundary 55 is formed between the cathode chamber 51 and the electrolyte 53. As shown in FIG. 2, a water vapor stream 56 is provided to the cathode chamber 51, and hydrogen gas 57 is produced from the cathode chamber 51.

Returning to FIG. 1, the method 1 begins with providing a water vapor stream to a cathode chamber of a SOEC; wherein the SOEC comprises a cathode chamber and an anode chamber, wherein the cathode chamber contains a catalyst; and wherein the catalyst comprises one or more conducting oxides and one or more catalytically active materials dispersed within said conducting oxides; and applying an electromagnetic field to the SOEC with a prescribed frequency and pulse mode specific to interactions of the catalyst and the electromagnetic field with the SOEC. In an embodiment, the prescribed frequency and pulse mode specific to interactions of the catalyst and the electromagnetic field with the SOEC provides uniform temperature distribution at the catalyst surface where the reaction takes place. In an embodiment, the prescribed frequency and pulse mode specific to interactions of the catalyst and the electromagnetic field with the SOEC provides increased SOEC efficiency by providing the optimum electromagnetic frequencies for heating the SOEC based on the materials within the SOEC. In an embodiment, the prescribed frequency and pulse mode specific interactions of the catalyst and the electromagnetic field with the SOEC is predetermined via empirical testing, wherein said empirical testing determines the optimal frequency and pulse mode to provide uniformly heat a surface of the catalyst, determines the optimal frequency and pulse mode for efficiency of the SOEC, and combinations thereof.

In the first step of method 1 shown in FIG. 1, an electromagnetic field is applied to the SOEC. In an embodiment, in the applying an electromagnetic field step 2 as described above, the electromagnetic field comprises microwaves, wherein said microwaves comprise a frequency or combination of frequencies between approximately 3 kHz to 300 GHz, preferably approximately 900 MHz to approximately 8 GHz, and typically approximately 915 MHz to approximately 2.45 GHz. Alternatively, in some embodiments, the electromagnetic field occurs by sweeping the frequency within a microwave frequency band over the 3 KHz to 300 GHz range, where the reaction optimally occurs at two or more frequencies ranging from about 3 KHz to 300 GHz, where the reaction occurs at two or multiple frequencies simultaneously or alternatively ranging from about 3 KHz to 300 GHz.

In some embodiments, in the applying an electromagnetic field step 2 as described above, an electromagnetic field is applied to the SOEC at a pulsing time ranging from about 1% to about 99% and a pulsing rate ranging from about 1% to about 75%.

In an embodiment, in the applying an electromagnetic field step 2 as described above, microwave energy is applied to the SOEC via a coaxial cable. In an embodiment, the coaxial cable carries both the microwave energy and DC bias, which can be separated upstream. In an alternative embodiment, microwave energy is applied via an antenna. In an alternative embodiment, microwave energy applied via an external microwave generator. In an embodiment, the microwave energy from the external microwave generator is applied as an electromagnetic wave to the SOEC and is evenly absorbed throughout the triple phase boundary. In another alternative embodiment, microwave energy is applied via an external microwave generator combined with waveguides. In an embodiment, two-port waveguides and deflectors are used to reduce reflections and standing wave patterns, direct microwave energy, and prevent thermal runaway.

In an embodiment, in the applying an electromagnetic field step 2 as described above, microwave energy provides targeted heating of the SOEC required for the electrolysis reaction, and also lowers the activation energy of the electrolysis reaction by applying specific microwave frequencies for the electrolysis reaction. In an embodiment, a focused microwave frequency band is directed to and contained in the cathode chamber of the SOEC, where the electrolysis reaction occurs. In some embodiments, microwave energy is applied to the SOEC in frequencies specific to the interactions of the catalyst and the electromagnetic field with the SOEC.

In some embodiments, in the applying an electromagnetic field step 2 as described above, a catalyst is used to support the electrolysis reaction at a triple phase boundary formed at the catalyst-cathode interface within in the cathode chamber of the SOEC, wherein the catalyst comprises a catalyst that absorbs microwave energy for localized heating and chemical excitation. The triple phase boundary is where the electrolysis reaction occurs. In an embodiment, the catalyst is a catalytically active material selected from the group of transition metals consisting of Ni, Fe, Cu, and Ru. These listed transition metals are exemplary and not meant to be limiting. A person having ordinary skill in the art could readily discern that any transition suitable for catalyzing water electrolysis can be used as a catalytically active material herein. In an embodiment, the catalyst comprises the catalytically active material dispersed within a conducting oxide or combination of conducting oxides, wherein said conducting oxide or combination of oxides are selected from perovskite, doped fluorite, samaria-doped ceria (SDC), gadolinium-doped ceria, yttria-stabilized zirconia, and combinations thereof.

In an embodiment, in the applying an electromagnetic field step 2 as described above, microwave energy provides targeted heating of the SOEC significantly faster than conventional heating, wherein, in conventional heating setups, the SOEC is resistively heated prior to heat transfer to the reaction medium by convection. Additionally, with this feature, in an embodiment, the invention increases the energy efficiency of SOEC, wherein the SOEC is heated nearly instantaneously to a targeted temperature using microwave energy depending on the materials of the SOEC.

In some embodiments, the applying an electromagnetic field step 2 increases the temperature of the water vapor stream and the SOEC to a range of about 400° C. to about 1000° C., and preferably between about 700° C. to about 900° C.

Returning to FIG. 1, the method continues with applying a DC bias 3 to the SOEC between its anode and cathode, resulting in production of some amount of hydrogen from the water vapor stream in the cathode chamber of the SOEC.

In an embodiment, in the applying a DC bias step 3 as described above, a DC bias is applied to the SOEC, resulting in the production of some amount of hydrogen. A person having ordinary skill in the art will readily ascertain that said DC bias can be any DC bias applied to the SOEC necessary for the electrolysis reaction to produce some amount of hydrogen at a given temperature and water vapor partial pressure.

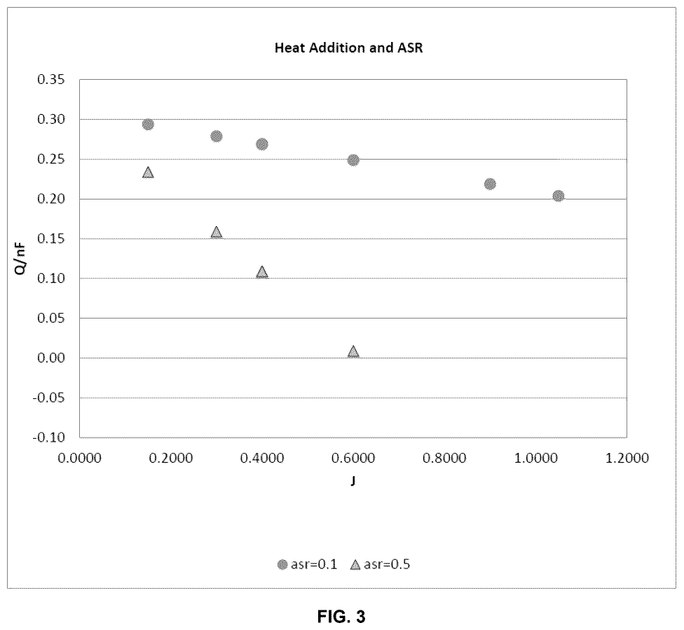

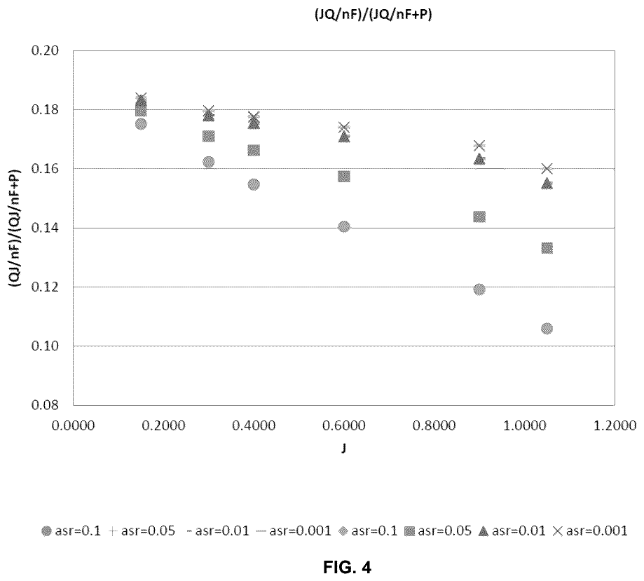

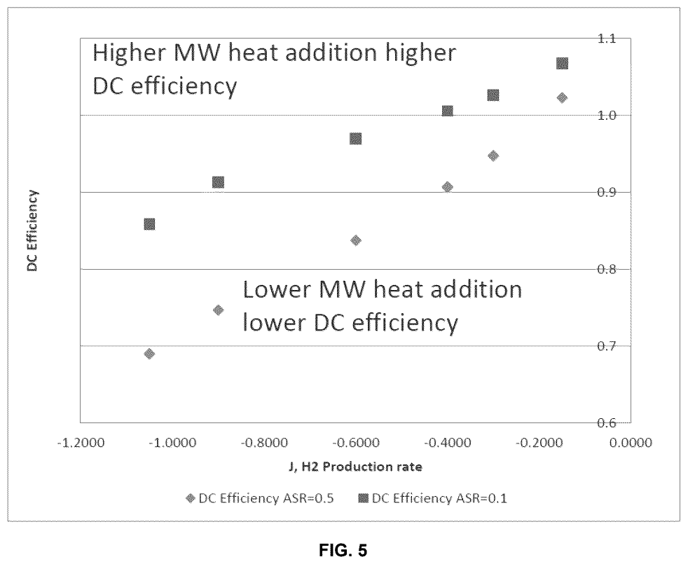

In an embodiment, in the applying a DC bias step 3 as described above, the application of microwave energy reduces the amount of power necessary to facilitate the electrolysis reaction in the SOEC by reducing the SOEC's ASR, thereby increasing the SOEC's DC efficiency. As shown in FIG. 3, a lower ASR corresponds with a greater amount of external energy (heat) required to be supplied to the SOEC in order to convert a given quantity of hydrogen from the water vapor stream, since the amount of heat internally generated from the SOEC is reduced. As shown in FIG. 4, for any given current, the fraction of total external energy that must be provided as external heat increases as ASR decreases. Consequently, with a lower ASR, more externally supplied heat can be supplied using microwaves, increasing the SOEC's DC efficiency compared to using resistive heating. As shown in FIG. 5, the greater the microwave heat addition, the higher the DC efficiency; when ASR is lowered through microwave addition, DC efficiency increases for any given current, because there is less electrical energy applied to drive the electrolysis reaction. As current and hydrogen production rate are directly related, higher microwave heat addition, higher DC efficiency, and lower ASR correlate with high hydrogen production rates. In some embodiments, the DC efficiency using microwaves increased between approximately 4% to approximately 25%, depending on the ASR.

In an embodiment, in the applying a DC bias step 3 as described above, hydrogen production rates increase by approximately 10% to approximately 20% when microwaves are applied to the SOEC compared to using resistive heating only. In an embodiment, a 250 MW SOEC system is capable of delivering approximately 10 to approximately 20 kilograms of hydrogen per hour.

A salient feature of the invention is that, in an embodiment, applying microwaves to the SOEC improves the efficiency of the SOEC by reducing its area specific resistance (ASR). In some embodiments, applying microwaves to the SOEC decreases the SOEC's ASR by a range of about 0 to about 2, and preferably by about 0.1 to about 0.6. The ASR of an SOEC decreases significantly as SOEC temperature increases. In an embodiment, the SOEC's temperature is increased by applying microwaves to the SOEC, which induces faster kinetics of the electrolysis reaction and thereby lowers the SOEC's ASR. Consequently, in an embodiment, lowering the SOEC's ASR results in increased current density and an increased hydrogen production rate for any given DC bias and water vapor partial pressure. An SOEC's power requirement varies greatly with ASR, wherein, as the ASR of the SOEC is reduced, the microwave energy required to achieve a designated hydrogen production rate rises, up to half the reaction's thermal neutral current. The thermal neutral current is the current at which the generated Joule heat in the SOEC equals the heat consumption for the electrolysis reaction.

In an embodiment, applying microwave energy to the SOEC induces faster kinetics of the electrolysis reaction, resulting in lower SOEC ASR. In an embodiment, applying microwave energy to the SOEC increases the temperature of ceramic materials composing the SOEC and thereby lowers the SOEC's ohmic resistance and thus lowers the SOEC's ASR. In addition, in some embodiments, microwave energy is targeted at the triple phase boundary at the catalyst-cathode interface, which results in localized increased temperatures, decreased local electrochemical overpotentials, and faster electrolysis reaction kinetics for a given DC bias to the SOEC. In some embodiments, a lower SOEC ASR via absorbed microwave energy to the SOEC will kinetically increase the endothermic electrolysis reaction and supply energy required for the electrolysis reaction to proceed in the SOEC. In some embodiments, microwave energy provides between approximately 10% to approximately 20% of the total energy to the SOEC to kinetically assist the electrolysis reaction.

In some embodiments, the method of enhancing an electrolysis reaction using microwaves disclosed herein lowers the overall hydrogen production costs compared to conventional resistive heating, as the costs to produce microwave heating is less than those using conventional resistive heating. Additionally, in some embodiments, the method of enhancing an electrolysis reaction using microwaves disclosed herein lowers overall hydrogen production costs by lowering the SOEC's ASR and thereby increasing the current density capable of being used in the SOEC, wherein current density is inversely proportional to overall hydrogen production costs.

In some embodiments, the method of enhancing an electrolysis reaction using microwaves disclosed herein enables the decoupling the power applied to the SOEC and the heating of the SOEC, resulting in decreased ASR, increased hydrogen production rates, increased DC efficiency, and increased capacity for heat addition using microwaves. Notably, in some embodiments, microwave energy is applied to the SOEC to increase reaction kinetics via coupling with the electrochemical reactions to lower ASR at the triple phase boundary, and also microwave energy separately is used to heat the triple phase boundary via an absorptive catalyst that converts microwaves to heat. This is in contrast to the prior art, where voltage is applied to both heat the SOEC and to drive the current required for the electrolysis reaction.

In some embodiments, the method of enhancing an electrolysis reaction using microwaves disclosed herein is coupled with renewable energy sources, thus reducing the carbon footprint of SOEC operation and hydrogen production.

In some embodiments, the method of enhancing an electrolysis reaction using microwaves disclosed herein is integrated with thermal waste streams, including from those from power plants and industrial processes, thus increasing the efficiency of the SOEC and hydrogen production.

In some embodiments, the method of enhancing an electrolysis reaction using microwaves disclosed herein enables high hydrogen production rates below the electrolysis reaction's thermal neutral point as driven without microwaves.

In some embodiments, the method of enhancing an electrolysis reaction using microwaves disclosed herein dramatically increases the lifespan of the SOEC compared to that when using conventional resistive heating, as resistive heating of the SOEC is reduced or eliminated. Additionally, in some embodiments, the method of enhancing an electrolysis reaction using microwaves disclosed herein decreases SOEC passivation and degradation.

In some embodiments, the method of enhancing an electrolysis reaction using microwaves disclosed herein is suitable for use with all types of SOECs for electrolysis of water, including proton conducting SEOCs (H-SOEC), reversible proton conducting SOECs (rH-SOEC) and reversible SOECs (rSOEC).

### EXAMPLES

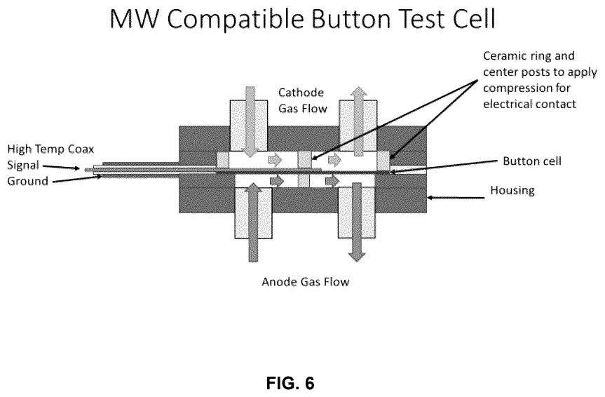

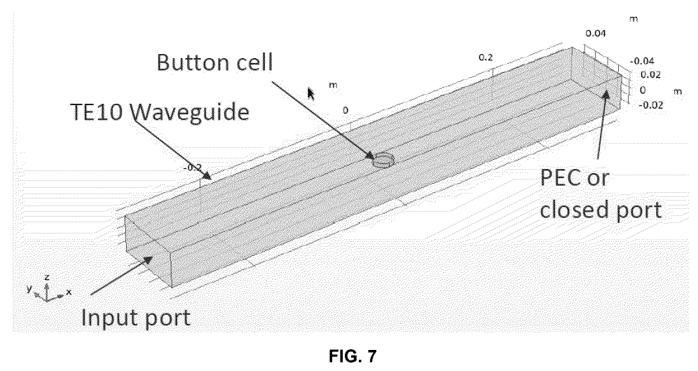

COMSOL modeling of a button test cell was performed as a proof of principle demonstration that microwaves can be used successfully to heat an SOEC. An exemplary embodiment of a button cell is shown in FIG. 6. The model, as shown in FIG. 7, simulates how a button cell comprising yttria-stabilized zirconia (YSZ) heats in a microwave reactor using a TE10 waveguide, which can host a 2450 MHz wave. In the model, a port power of 220 W was utilized at an input port of the waveguide, and a secondary port was closed to reflect power back to the cell. Other parameters of the model included convective cooling at 2 W/m²K; a heat sink at 0.002 kJ/s, based on enthalpy of the reaction and flow rate; and a steady state solution at f=2450 MHz. The button cell comprised a radius of 1.2 cm and a height of 0.5 cm. No flow, cathode and anode layers, or coating were modeled.

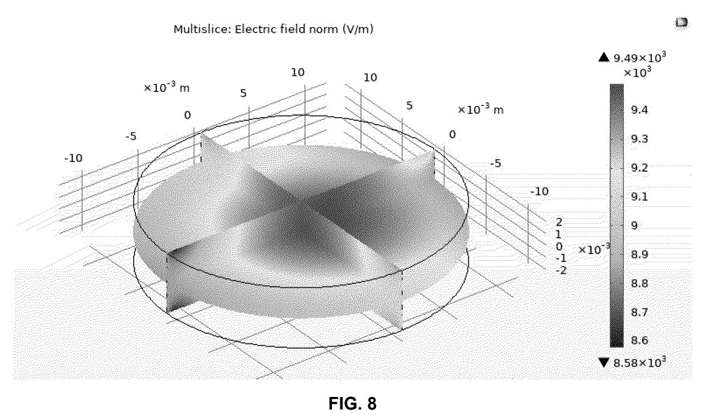

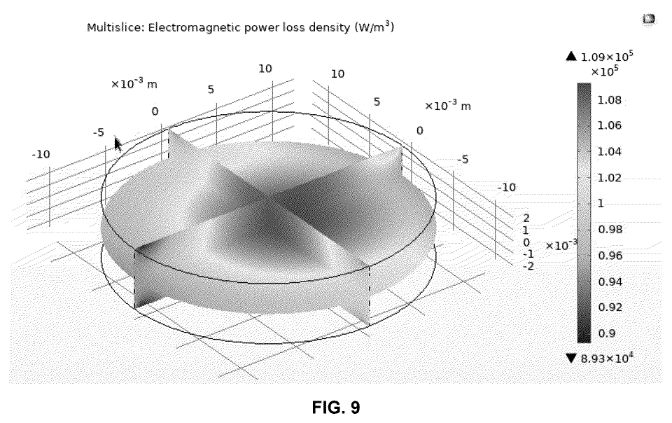

As shown in FIG. 8, the electric field of the model button cell ranged from about 8580 V/m to about 9490 V/m. As shown in FIG. 9, the electromagnetic power loss density of the model button cell ranged from about 89300 W/m³ to 109000 W/m³. Input power to the model button cell was 220 W, and to reach a temperature of 851° C., the power absorbed by the whole volume of the model button cell was 1.0153 W. Based on the model button cell's dimensions, the above translates to 0.08 W/cm². The reflected power of the model was 218.98 W.

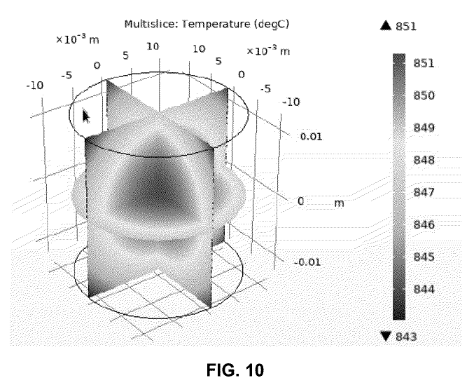

As shown in FIG. 10, a model of a stacked button cell with a radius of 1.2 cm and a width of 2.5 cm was constructed, where approximately 90 W of power input resulted in a temperature of 851° C. The power absorbed by the model stacked button cell was 2.3037 W, which translates to 0.0825 W/cm², where power absorbed (P_{abs}) is a function of the dielectric loss of a material that follows the equation P_{abs}=2*π*f*ε″*E². For example, the power absorbed when ε″ is 0.009 is 0.08 W/cm², but when ε″* is 0.045, P_{abs} is 0.24 W/cm². Thus, there is a decrease in reflected power for a model button cell with larger dimensions. In sum, COMSOL modeling proves that microwave addition can be used to heat an SOEC, and further engineering design optimization will likely lead to efficient and effective SOEC designs using standard materials.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A method of enhancing an electrolysis reaction in a solid oxide electrolysis cell (SOEC) for hydrogen production, comprising:
providing a water vapor stream to a cathode chamber of a SOEC;
wherein the SOEC comprises the cathode chamber and an anode chamber, wherein the cathode chamber contains a catalyst; and
wherein the catalyst comprises one or more conducting oxides and one or more catalytically active materials dispersed within said conducting oxides; and applying an electromagnetic field to the SOEC with a prescribed frequency and pulse mode specific to interactions of the catalyst and the electromagnetic field with the SOEC; and applying a DC bias to the SOEC, resulting in production of some amount of hydrogen from the water vapor stream in the cathode chamber of the SOEC.

2. The method of claim 1 wherein the electrolysis reaction is an endothermic reaction.

3. The method of claim 1 wherein the conducting oxide is selected from a group consisting of doped fluorite, samaria-doped ceria (SDC), gadolinium-doped ceria, yttria-stabilized zirconia, perovskite, and combinations thereof.

4. The method of claim 1 wherein the catalytically active material is a transition metal selected from a group consisting of Ni, Fe, Cu, Ru, and combinations thereof.

5. The method of claim 1 wherein the electromagnetic field comprises a frequency between about 300 MHz to about 300 GHz.

6. The method of claim 1 wherein the electromagnetic field is applied to the SOEC at a pulsing time ranging from about 1 to 99%.

7. The method of claim 6 wherein the electromagnetic field is applied to the SOEC at a pulsing rate from about 1% to 75%.

8. The method of claim 1 wherein applying an electromagnetic field to the SOEC increases the temperature of the water vapor stream and the SOEC to a range of about 400° C. to about 1000° C.

9. The method of claim 1 wherein applying an electromagnetic field to the SOEC decreases an area specific resistance (ASR) of the SOEC by a range of about 0 to about 2.

10. The method of claim 1, wherein the method yields hydrogen at a rate of about 10 to about 20 kg/hr at a microwave power of about 250 MW.

11. A method of enhancing an electrolysis reaction in a solid oxide electrolysis cell (SOEC) by applying an electromagnetic field for hydrogen production, comprising:
providing a water vapor stream to a cathode chamber of a SOEC;
wherein the SOEC comprises the cathode chamber and an anode chamber, wherein the cathode chamber contains a catalyst; and
wherein the catalyst comprises one or more conducting oxides and one or more catalytically active materials dispersed within said conducting oxides; and applying an electromagnetic field to the SOEC with a prescribed frequency and pulse mode specific to interactions of the catalyst and the electromagnetic field with the SOEC; and applying a DC bias to the SOEC, resulting in production of some amount of hydrogen from the water vapor stream in the cathode chamber of the SOEC.

12. The method of claim 11 wherein the electrolysis reaction is an endothermic reaction.

13. The method of claim 11 wherein the conducting oxide is selected from a group consisting of doped fluorite, samaria-doped ceria (SDC), gadolinium-doped ceria, yttria-stabilized zirconia, perovskite, and combinations thereof.

14. The method of claim 11 wherein the catalytically active material is a transition metal selected from a group consisting of Ni, Fe, Cu, Ru, and combinations thereof.

15. The method of claim 11 wherein the electromagnetic field comprises a frequency between about 300 MHz to about 300 GHz.

16. The method of claim 11 wherein the electromagnetic field is applied to the SOEC at a pulsing time ranging from about 1 to 99%.

17. The method of claim 16 wherein the electromagnetic field is applied to the SOEC at a pulsing rate from about 1% to 75%.

18. The method of claim 11 wherein applying an electromagnetic field to the SOEC increases the temperature of the water vapor stream and the SOEC to a range of about 400° C. to about 1000° C.

19. The method of claim 11 wherein applying an electromagnetic field to the SOEC decreases an area specific resistance (ASR) of the SOEC by a range of about 0 to about 2.

20. The method of claim 11, wherein the method yields hydrogen at a rate of about 10 to about 20 kg/hr at a microwave power of about 250 MW.
